(19) United States
(12) Patent Application Publication
(10) Pub. No.: US 2014/0117021 A1
(43) Pub. Date: May 1, 2014

(54) Cryogenic Fluid Tank and Its Use

(71) Applicants: Sophie Quemerais, Sassenage (FR); Francois Barbier, La Tronche (FR)

(72) Inventors: Sophie Quemerais, Sassenage (FR); Francois Barbier, La Tronche (FR)

(73) Assignee: L'Air Liquide Societe Anonyme Pour L'Etude Et L'Exploitation Des Procedes Georges Claude, Paris (FR)

(21) Appl. No.: 14/128,432

(22) PCT Filed: Jun. 25, 2012
(86) PCT No.: PCT/FR2012/051449

§ 371 Date: Dec. 20, 2013

(30) Foreign Application Priority Data
Jul. 1, 2011 (FR) 1155948

(51) Int. Cl. F17C 13/00

(52) U.S. Cl. CPC F17C 13/001
USPC 220/560.12

(57) ABSTRACT

Cryogenic fluid tank for a launch rocket, comprising at least one wall delimiting a storage space for cryogenic fluid, said wall being provided, on at least part of the internal surface thereof, with thermal insulation comprising a so-called top layer intended to be in contact with the fluid stored in the storage space, characterized in that the top layer comprises an insulating material covered, on the face thereof intended to be in contact with the cryogenic fluid stored in the tank, with an impervious enclosure forming an impervious barrier between the cryogenic fluid stored and the insulating material, and in that the insulating material of the top layer is completely encapsulated in an impervious enclosure, that is to say the insulating material is covered by the impervious enclosure over its entire surface.

The present invention concerns a tank for cryogenic fluid for a launch rocket and use thereof.

The invention concerns more particularly a cryogenic fluid tank for a launch rocket comprising at least one wall delimiting a storage space for cryogenic fluid, said wall being provided, on at least part of the internal surface thereof, with thermal insulation comprising a so-called top layer intended to be in contact with the fluid stored in the storage space.

The invention concerns a thermal insulation device for launch rocket cryogenic tanks, in particular for liquid hydrogen tanks. The insulation can be applied to so-called common-bottom tanks between two storage spaces provided for two separate fluids (hydrogen and oxygen for example), for which insulation must be put on the wall separating the two spaces, on the same side as one of the fluids (on the hydrogen side for example).

The invention can also apply to the internal insulation for a tank for reusable launch rockets for which, because of the presence of external (so-called hot) thermal insulation provided for the phase of re-entry into the atmosphere, it is preferable to place the (so-called cold) cryogenic insulation inside the tank, in particular on the cylindrical areas of the tank.

One known insulation solution for this type of tank consists of placing a layer of insulation with a honeycomb structure between two walls and providing vacuum insulation of this structure. This solution is however expensive and complex, in particular for large tanks.

Another known solution consists of placing, on the internal surface of the tanks, a layer of insulation having a rigid impervious foam structure. This impervious rigid insulation is for example the one designated by the reference H920A from the company Air Liquide.

The latter solution insulates the tanks satisfactorily but may have drawbacks when the layer of insulation is subjected to very low temperatures (20 K for example) for relatively long periods (several hours). This is because the applicant has found that, because of the relative thermal contraction between the wall of the tank (aluminium alloy in general) and the insulation foam (subjected to a temperature such as 20 K for example), and because of the very small permissible elongation of this foam, cracks are liable to occur in the insulating structure. These cracks degrade the insulation performance of the tank, in particular by the circulation of cryogenic liquid in these cracks.

One aim of the present invention is to overcome all or some of the drawbacks of the prior art noted above.

To this end, the tank according to the invention, moreover in accordance with the generic definition given to it in the above preamble, is essentially characterised in that the top layer comprises an insulating material covered, on the face thereof intended to be in contact with the cryogenic fluid stored in the tank, with an impervious enclosure forming an impervious barrier between the cryogenic fluid stored and the insulating material.

Moreover, embodiments of the invention may comprise one or more of the following features:
the insulating material of the top layer is covered with the impervious enclosure only on the face thereof turned towards the inside of the storage space, at the periphery of the impervious material of the top layer, the impervious enclosure being fixed to the wall of the tank in order to provide an impervious barrier between the cryogenic fluid stored and the insulating material,
the insulating material of the top layer is completely encapsulated in an impervious enclosure, that is to say the insulating material is covered by the impervious enclosure over its entire surface,
when the top layer is exposed to an ambient temperature of around 20° C., the insulating material of the top layer is encapsulated in the impervious enclosure at a pressure below atmospheric pressure,
when the top layer is exposed to an ambient temperature of around 20° C., the insulating material of the top layer is encapsulated in the impervious enclosure under vacuum at a pressure of between 10⁻⁴ mbar and 100 mbar,
when the top layer is exposed to an ambient temperature of around 20° C., the insulating material of the top layer is encapsulated in the impervious enclosure at atmospheric pressure,
the insulating material of the top layer is encapsulated in the impervious enclosure under an atmosphere of air and/or at least one of the following gases: nitrogen, carbon dioxide (CO₂), neon,
the insulating material of the top layer comprises at least one from: glass microspheres, aerogels in powder form, granules or coverings, a cellular material with open or closed cells,
the top layer is flexible or semi-rigid,
the top layer is bonded directly to the internal face of the wall of the tank,
the top layer is bonded to the internal face of a so-called bottom insulation layer,
the bottom insulation layer is bonded directly to the internal face of the wall of the tank,
the bottom insulation layer is rigid or semi-rigid and comprises at least one of the following materials: PVC, PEI, PU,
at atmospheric pressure, the top layer has a thickness of between 10 and 40 mm and preferably between 15 and 30 mm,
the wall is metal, made from aluminium alloy or composite material,
the wall delimits an internal storage space with respect to the hot space external to the tank,
the tank is of the common-bottom type comprising two separate internal cryogenic storage spaces intended to store distinct liquids separately, said wall being an inter-space wall delimiting the first internal storage space with respect to the second internal storage space,
the bottom insulation layer has a thickness of between 5 and 60 mm and preferably between 10 mm and 30 mm,
the impervious enclosure of the top layer (2) comprises at least one from the following materials: PE (polyethylene), PET (polyethylene terephthalate), PA (polyamide), PI, PTFE (polytetrafluoroethylene) or aluminised film, and has a thickness of between 0.015 mm and 1.5 mm.

The invention also concerns the use of a tank according to any one of the preceding features for storing a cryogenic fluid, the fluid being stored in the tank at a pressure of between 3 bar and 5 bar.

The invention may also concern any alternative device or method comprising any combination of the aforementioned or following features.

Other particularities and advantages will emerge from a reading of the following description, given with reference to the figures, in which:

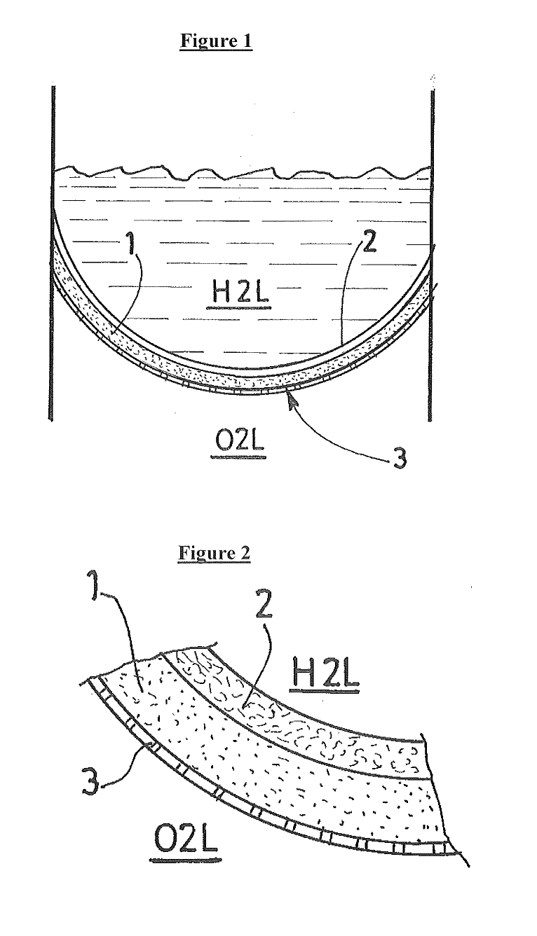

FIG. 1 shows a partial schematic view in section illustrating the arrangement of an insulation device in a common-bottom tank according to a first example embodiment of the invention,

FIG. 2 shows an enlarged view of a detail of FIG. 1 illustrating the arrangement of the insulation on a wall of the tank,

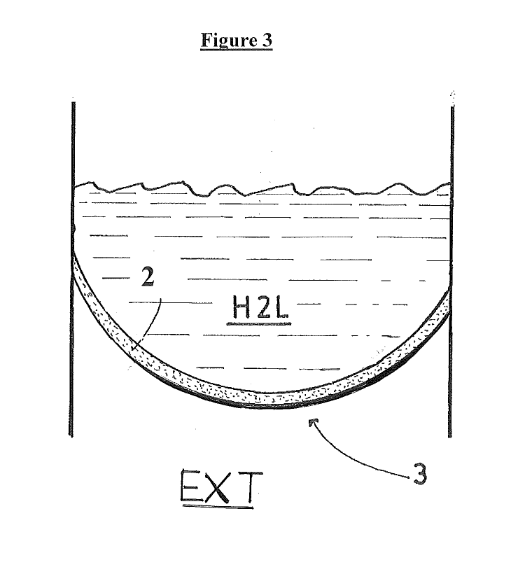

FIG. 3 shows a partial schematic view in section illustrating the arrangement of an insulation device in a tank according to a second example embodiment of the invention.

Referring to FIG. 1, at least the wall 3 of a cryogenic tank comprises, on its internal surface in communication with the cryogenic liquid stored in the tank (H2L), thermal insulation.

In the example embodiment shown in FIGS. 1 and 2, this insulation structure is disposed on one face of an internal wall 3 separating two adjacent storage spaces in the same tank. Such a common-bottom tank makes it possible to store two distinct fluids separately (for example liquid hydrogen (H2L) and liquid oxygen (O2L). The insulation device is disposed on the face of the wall situated on the same side as the liquid hydrogen (colder).

This thermal insulation structure comprises a top layer 2 fixed to a bottom insulating layer 1, the bottom layer 1 being itself fixed to the internal face of the wall 3 of the tank.

The bottom layer 1 comprises for example a PVC foam bonded to the wall 3. This bottom layer 1 made from rigid insulation, where applicable, has a thickness of between 5 and 60 mm for example.

The top layer 2 consists of an insulating material encapsulated in an impervious enclosure. This top layer 2 makes it possible to obtain high-performance thermal insulation since the cryogenic fluid does not enter therein.

Preferably, without this being limitative, the insulation of this top layer 2 is encapsulated under negative pressure or vacuum in the impervious enclosure.

When the tank is filled with cryogenic liquid (liquid nitrogen, liquid hydrogen, or other), all or some of the residual gas present in the enclosure of the top layer 2 is condensed, or even “cryopumped”. This creates or increases a negative pressure in the top layer 2 (in the impervious enclosure).

The top layer 2 has a thickness of between for example 10 and 40 mm (before putting under vacuum or negative pressure) and preferably between 15 and 30 mm.

In this way, the insulating material in the impervious enclosure is under negative pressure or relative vacuum. This confers on the whole very good insulating performance. This is because this makes it possible to increase the temperature on the surface of the bottom insulation layer 1.

This architecture makes it possible to obtain a reduced differential contraction between on the one hand the wall 3 of the tank and on the other hand the bottom insulation layer 1, the latter preferably being rigid.

The elongation at break of the bottom layer 1 also being higher, the top layer 2 thus limits the risks of cracking in the bottom layer 1.

In the example described above, the top layer 2 comprises an insulating material completely encapsulated in an impervious enclosure. Naturally, in a variant, this insulating material may be just covered by the impervious enclosure on its face turned towards the inside of the tank. In this case, the seal between the insulating material and the stored liquid is effected at the periphery with the walls of the tank (the enclosure is connected or bonded sealingly to the wall 3 of the tank).

The impervious enclosure of the top layer 2 comprises at least one from the following materials: PE, PET, PA, PI, PTFE or aluminised film and has a thickness of between 0.015 mm and 1.5 mm.

The embodiment in FIG. 3 is distinguished from that of FIGS. 1 and 2 solely in that the insulation does not comprise a bottom layer 1. That is to say the top layer 2 is bonded directly to the internal face of the wall 3.

In the examples in FIGS. 1 to 3, the insulation (top layer 2 optionally associated with a bottom layer 1) is positioned on the concave side of the wall separating two storage spaces of the same tank (the case of a common bottom). Naturally, it is possible also to provide this insulation on the convex side of the wall.

Likewise, the insulation structure described above is also particularly suited to forming an optimum insulation between the interior of a tank containing liquid hydrogen (H2L) (or any other cryogenic liquid) and the outside (EXT, cf. FIG. 3).

While being of simple and inexpensive structure, the invention makes it possible to effectively insulate the tanks of launch rockets.

1-15. (canceled)

16. A cryogenic fluid tank for a launch rocket, comprising at least one wall delimiting a storage space for cryogenic fluid, said wall being provided, on at least part of the internal surface thereof, with thermal insulation comprising a so-called top layer intended to be in contact with the fluid stored in the storage space, characterized in that the top layer comprises an insulating material covered, on the face thereof intended to be in contact with the cryogenic fluid stored in the tank, with an impervious enclosure forming an impervious barrier between the cryogenic fluid stored and the insulating material, and in that the insulating material of the top layer (2) is completely encapsulated in an impervious enclosure.

17. The tank of claim 16, wherein the insulating material of the top layer is covered with the impervious enclosure only on the face thereof turned towards the inside of the storage space and in that, at the periphery of the impervious material of the top layer, the impervious enclosure is fixed to the wall of the tank in order to provide an impervious barrier between the cryogenic fluid stored and the insulating material.

18. The tank of claim 16, wherein when the top layer is exposed to an ambient temperature of around 20° C., the insulating material of the top layer is encapsulated in the impervious enclosure at a pressure below atmospheric pressure.

19. The tank of claim 16, wherein when the top layer is exposed to an ambient temperature of around 20° C., the insulating material of the top layer is encapsulated in the impervious enclosure under vacuum at a pressure of between 10⁻⁴ mbar and 100 mbar.

20. The tank of claim 16, wherein when the top layer is exposed to an ambient temperature of around 20° C., the insulating material of the top layer is encapsulated in the impervious enclosure at atmospheric pressure.

21. The tank of claim 16, wherein the insulating material of the top layer is encapsulated in the impervious enclosure under an atmosphere of air and/or at least one of the following gases: nitrogen, carbon dioxide (CO₂), neon.

22. The tank of claim 16, wherein the insulating material of the top layer comprises at least one from: glass microspheres, aerogels in powder form, granules or coverings, a cellular material with open or closed cells.

23. The tank of claim 16, wherein the top layer is flexible or semi-rigid.

24. The tank of claim 16, wherein the top layer is bonded directly to the internal face of the wall of the tank.

25. The tank of claim 16, wherein the top layer is bonded to the internal face of a so-called bottom insulation layer.

26. The tank of claim 25, wherein the bottom insulation layer is bonded directly to the internal face of the wall of the tank.

27. The tank of claim 25, wherein the bottom insulation layer is rigid or semi-rigid and comprises at least one of PVC, PEI, and PU.

28. The tank of claim 16, wherein at atmospheric pressure, the top layer has a thickness of between 10 and 40 mm and preferably between 15 and 30 mm.

29. The tank of claim 16, wherein the impervious enclosure of the top layer comprises at least one of the following materials: PE, PET, PA, PI, PTFE or an aluminised film and has a thickness of between 0.015 mm and 1.5 mm.

30. A cryogenic fluid storage system, comprising the tank of claim 16 in which a cryogenic fluid is stored at a pressure of between 3 bar and 5 bar.
